(19) United States
(12) Patent Application Publication
(10) Pub. No.: US 2025/0317924 A1
(43) Pub. Date: Oct. 9, 2025

(54) ENERGY AWARE SCHEDULING FOR WIRELESS DEVICES

(71) Applicant: Lenovo (Singapore) Pte. Limited, Singapore (SG)

(72) Inventors: Karthikeyan Ganesan, Nauheim (DE); Ali Ramadan Ali, Kraiburg (DE); Ravi Kuchibhotla, Chicago, IL (US)

(73) Assignee: Lenovo (Singapore) Pte. Limited, Singapore (SG)

(21) Appl. No.: 19/085,480

(22) Filed: Mar. 20, 2025

Related U.S. Application Data
(60) Provisional application No. 63/575,537, filed on Apr. 5, 2024.

(51) Int. Cl. H04W 72/1263

(52) U.S. Cl. CPC H04W 72/1263

(57) ABSTRACT

Various aspects of the present disclosure relate to energy aware scheduling for wireless devices. A wireless device receives a configuration for communication with a reader. The wireless device selects, based at least in part on a rule or formula, an interval of a plurality of intervals for transmission. The wireless device transmits, within an occasion of one of the plurality of intervals for transmission, at least one of random access or an electronic product code identifier.

### RELATED APPLICATION

This application claims priority to U.S. Patent Application Ser. No. 63/575,537 filed Apr. 5, 2024 entitled “ENERGY AWARE SCHEDULING FOR WIRELESS DEVICES,” the disclosure of which is incorporated by reference herein in its entirety.

### TECHNICAL FIELD

The present disclosure relates to wireless communications, and more specifically to energy aware scheduling for wireless devices.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

An apparatus (e.g., a UE or Ambient Internet of Things (IoT) device) for wireless communication is described. The apparatus may be configured to, capable of, or operable to perform one or more operations as described herein. For example, the apparatus may be configured to, capable of, or operable to receive a configuration for communication with a reader; select, based at least in part on a rule or formula, an interval of a plurality of intervals for transmission; transmit, within an occasion of one of the plurality of intervals for transmission, at least one of random access or an electronic product code identifier.

A processor (e.g., a standalone processor chipset, or a component of a UE or of an Ambient IoT device) for wireless communication is described. The processor may be configured to, capable of, or operable to perform one or more operations as described herein. For example, the processor may be configured to, capable of, or operable to receive a configuration for communication with a reader; select, based at least in part on a rule or a formula, an interval of a plurality of intervals for transmission; transmit, within an occasion of one of the plurality of intervals for transmission, at least one of random access or an electronic product code identifier.

A method performed or performable by an apparatus (e.g., a UE or Ambient IoT device) for wireless communication is described. The method may include receiving a configuration for communication with a reader; selecting, based at least in part on a rule or formula, an interval of a plurality of intervals for transmission; and transmitting, within an occasion of one of the plurality of intervals for transmission, at least one of random access or an electronic product code identifier.

In some implementations of the apparatus, the processor, and the method described herein, the configuration indicates at least one of a duration of an inventory round or multiple intervals within the inventory round, where each of the multiple intervals includes multiple occasions.

In some implementations of the apparatus, the processor, and the method described herein, the rule or formula is based at least in part on one or more of a duration of an inventory round, a duration between query messages in the inventory round, an energy harvesting time for the wireless device according to a harvesting source, an energy harvesting time for the wireless device based at least in part on a capacitance size and resistance of the wireless device, an available energy of the wireless device, or an estimated energy consumption for at least one of reception, sleep, transmission, or synchronization by the wireless device.

In some implementations of the apparatus, processor, and method described herein, the apparatus, processor, and method may further be configured to, capable of, performed, performable, or operable to select the occasion. In some implementations of the apparatus, processor, and method described herein, the apparatus, processor, and method may further be configured to, capable of, performed, performable, or operable to select the occasion according to a contention-based scheme.

In some implementations of the apparatus, processor, and method described herein, the apparatus, processor, and method may further be configured to, capable of, performed, performable, or operable to select a transmission slot within the occasion for transmission of the electronic product code identifier according to a contention-less approach. In some implementations of the apparatus, processor, and method described herein, to select the interval, the apparatus, processor, and method may further be configured to, capable of, performed, performable, or operable to select the interval based at least in part on available energy at the wireless device.

In some implementations of the apparatus, processor, and method described herein, to select the interval, the apparatus, processor, and method may further be configured to, capable of, performed, performable, or operable to select an interval of the plurality of intervals earlier in time based at least in part on available energy at the wireless device being less than a threshold amount. In some implementations of the apparatus, processor, and method described herein, the apparatus, processor, and method may further be configured to, capable of, performed, performable, or operable to select the interval based at least in part on an energy harvesting time of the wireless device.

In some implementations of the apparatus, processor, and method described herein, the apparatus, processor, and method may further be configured to, capable of, performed, performable, or operable to transmit an indication of available energy at the wireless device. In some implementations of the apparatus, processor, and method described herein, the apparatus, processor, and method may further be configured to, capable of, performed, performable, or operable to, after transmission of at least one of the random access or the electronic product code identifier, enter a sleep mode until an inventory round that includes the plurality of intervals for transmission has ended.

In some implementations of the apparatus, processor, and method described herein, the wireless device comprises a low power device. In some implementations of the apparatus, processor, and method described herein, the wireless device comprises an Ambient Internet of Things (IoT) device.

An NE (e.g., a base station) for wireless communication is described. The NE may be configured to, capable of, or operable to perform one or more operations as described herein. For example, the NE may be configured to, capable of, or operable to transmit a configuration for communication with a wireless device for selection of an interval of a plurality of intervals for transmission; receive, within an occasion of one of the plurality of intervals for transmission, at least one of random access or an electronic product code identifier.

A processor (e.g., a standalone processor chipset, or a component of a NE (e.g., a base station)) for wireless communication is described. The processor may be configured to, capable of, or operable to perform one or more operations as described herein. For example, the processor may be configured to, capable of, or operable to transmit a configuration for communication with a wireless device for selection of an interval of a plurality of intervals for transmission; receive, within an occasion of one of the plurality of intervals for transmission, at least one of random access or an electronic product code identifier.

A method performed or performable by an NE (e.g., a base station) for wireless communication is described. The method may include transmitting a configuration for communication with a wireless device for selection of an interval of a plurality of intervals for transmission; and E receiving, within an occasion of one of the plurality of intervals for transmission, at least one of random access or an electronic product code identifier.

In some implementations of the NE, the processor, and the method described herein, the configuration indicates at least one of a duration of an inventory round or multiple intervals within the inventory round, where each of the multiple intervals includes multiple occasions. In some implementations of the NE, processor, and method described herein, the NE, processor, and method may further be configured to, capable of, performed, performable, or operable to receive an indication of available energy at the wireless device.

In some implementations of the NE, the processor, and the method described herein, the wireless device comprises a low power device. In some implementations of the NE, the processor, and the method described herein, the wireless device comprises an Ambient IoT device.

### BRIEF DESCRIPTION OF THE DRAWINGS

FIGS. 1 and 2 illustrate examples of wireless communications systems in accordance with aspects of the present disclosure.

FIG. 3 illustrates an example of duty cycle based operation in accordance with aspects of the present disclosure.

FIG. 4 illustrates an example of grouping of resources in accordance with aspects of the present disclosure.

FIG. 5 illustrates an example of uplink (UL) resource allocation in accordance with aspects of the present disclosure.

FIG. 6 illustrates an example of a device in accordance with aspects of the present disclosure.

FIG. 7 illustrates an example of a processor in accordance with aspects of the present disclosure.

FIG. 8 illustrates an example of a NE in accordance with aspects of the present disclosure.

FIGS. 9 and 10 illustrate flowcharts of methods in accordance with aspects of the present disclosure.

### DETAILED DESCRIPTION

For various applications, numerous (e.g., billions) of Internet of Things (IoT) devices are expected to be deployed in a wireless communications system. However, it is difficult to power this large number of devices with batteries that need to be replaced for re-charging, which leads to high maintenance cost. Accordingly, devices that consume very low power and/or rely on harvesting the energy are considered. One example of such a device is a device (e.g., referred to as a passive device) that has no energy storage, no independent signal generation, and uses backscattering transmission. Another example of such a device is a device (e.g., referred to as a semi-passive device) that has energy storage, no independent signal generation, and uses backscattering transmission. Use of stored energy can include amplification for reflected signals. Another example of such a device is a device (e.g., referred to as an active device) that has energy storage, has independent signal generation (e.g., an active RF component for transmission), and may use backscattering transmission.

IoT devices may include Ambient IoT devices. An Ambient IoT device refers to a low-power (e.g., self-powered) sensor or device, which is typically small and/or low-cost. For example, Ambient IoT devices may include an energy harvester with an output power of from 1 microwatt (μW) to a few hundreds of μW. Ambient IoT devices also typically do not include a subscriber identity module (SIM) card. There are different topologies and deployment scenarios of Ambient IoT devices. Examples of these topologies include a topology where a base station acts as reader and as source of a carrier wave, a topology where the base station acts as a reader but another device is used as a source of the carrier wave, a topology where the base station acts as a controller and another intermediate node is used as a reader and as a source of the carrier wave, and so forth.

In some scenarios, there can be a large number of Ambient IoT devices (e.g., as many as 150 devices per 100 square meters (m2)), such as in an indoor factory area where Ambient IoT devices are attached to objects (e.g., products, boxes, pallets) being tracked. These devices do random access and data transmission for transmitting, e.g., an electronic product code identifier (ID) to the network. Traditional radio frequency identification (RFID) techniques use an aloha protocol, a tree protocol, a Q protocol, and so forth to access the channel, resolves collision and transmit data.

The energy of such devices (e.g., Ambient IoT devices or other low power wireless devices) is limited due to storage capacitor size and the charging time depends on the energy harvesting circuitry and its resistance and capacitance. An Ambient IoT device may be fully charged (e.g., storing an amount of energy approximately equal to (e.g., within a threshold amount, such as 5%) the energy storage capacity of the Ambient IoT device), be partially charged (e.g., storing an amount of energy less than the energy storage capacity of the Ambient IoT device), or have no charge (e.g., storing no energy or less than a threshold amount (e.g., less than 2%) of the energy storage capacity of the Ambient IoT device). Additionally, depending on the available energy at the Ambient IoT device, it may be possible for the device to sustain the length of the inventory round, and also harvest energy during the inventory round depending on the charging time (e.g., energy harvesting time) of the Ambient IoT device to further sustain the operations within the inventory round.

The techniques discussed herein provide energy aware scheduling for Ambient IoT devices. Energy aware scheduling refers to the scheduling of Ambient IoT devices for transmission based at least in part on the energy capabilities of the Ambient IoT devices, such as an amount of energy stored at the Ambient IoT devices, the energy harvesting times of the Ambient IoT devices (e.g., how long it takes or a rate at which each of the Ambient IoT devices harvests energy), and so forth. The techniques discussed herein are described with reference to an inventory request command (also referred to as simply an inventory request or an inventory command), where the Ambient IoT devices receive the inventory request command and transmit their identifiers (e.g., electronic product code (EPC) identifiers (IDs)) to a reader device. However, it is to be appreciated that the techniques discussed herein can be applied analogously to other types of commands.

In order to identify Ambient IoT devices at a particular location (e.g., within wireless communication range of at least one reader device), an inventory round (also referred to as an inventory process) is performed. To perform an inventory round, a reader device transmits a configuration (also referred to as an inventory configuration) to the Ambient IoT devices. The configuration indicates various information regarding the inventory round, such as one or more of a duration of the inventory round, a number of intervals within the inventory round, a number of occasions within each interval, energy thresholds associated with each of the intervals, and the like.

The reader device then transmits an inventory request command, which is received by the Ambient IoT devices. The duration of the inventory round is divided into multiple intervals and each interval includes multiple occasions in which an Ambient IoT device can transmit, such as a random access (e.g., a random access channel (RACH) preamble) or data (e.g., an EPC ID). Each Ambient IoT device selects or determines, based at least in part on a rule or formula, one of the multiple intervals in which Ambient IoT device is to transmit. For each Ambient IoT device, the rule or formula accounts for the energy capabilities of the Ambient IoT device. For example, an Ambient IoT device with less available energy can select an interval earlier in the inventory round for transmission than an Ambient IoT device with more available energy. By way of another example, an Ambient IoT device that is going to harvest additional energy in order to make the transmission can select an interval later in the inventory round for transmission to give the Ambient IoT device time to harvest the energy.

Accordingly, the techniques discussed herein allow the Ambient IoT devices to be grouped based on energy capabilities of the Ambient IoT devices. This grouping of the Ambient IoT devices allows different subpopulations of the Ambient IoT devices to be selected for random access and to transmit data at different times within the inventory round. This reduces the number of collisions that occur due to two or more Ambient IoT devices transmitting at the same time, and allows the Ambient IoT devices to be more responsive to inventory requests (e.g., by responding in an earlier interval prior to running out of power or by responding at a later interval after harvesting energy for the transmission).

Reference is made herein to receiving, transmitting, or communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth. Similarly, other terms may be used interchangeably with transmitting (e.g., communicating, signaling, outputting, forwarding, and so forth), and other terms may be used interchangeably with receiving (e.g., communicating, retrieving, obtaining, and so forth).

Aspects of the present disclosure are described in the context of a wireless communications system.

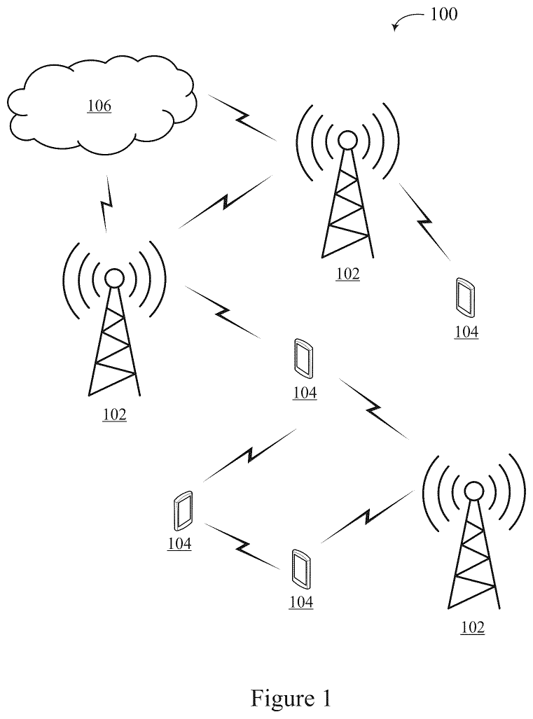

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHZ-7.125 GHZ), FR2 (24.25 GHz-52.6 GHZ), FR3 (7.125 GHZ-24.25 GHZ), FR4 (52.6 GHZ-114.25 GHZ), FR4a or FR4-1 (52.6 GHz-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologics). For example, FR2 may be associated with a third numerology (e.g., μ=2), which includes 60 kHz subcarrier spacing; and a fourth numerology (e.g., μ=3), which includes 120 kHz subcarrier spacing.

In some cases, a cell refers to a radio access node in communication with a base station or including a base station. A cell typically has a coverage area, which is a geographic area in which the cell provides wireless connectivity to devices within. Different cells may operate on defined frequencies or frequency bands, referred to as subcarriers. In some examples, a UE 104 establishes a wireless connection with a cell, and subsequently that cell may be referred to as a serving cell of the UE 104.

In one or more implementations, the wireless communications system 100 also includes one or more Ambient IoT devices. The techniques discussed herein allow a NE 102 to select a subpopulation of Ambient IoT devices for random access and to transmit data. Different subpopulations are selected at different times, allowing all of the Ambient IoT devices in the population (e.g., in the factory) to eventually be able to perform random access and transmit data. An NE 102 (e.g., a base station) configures resources for random access and transmission of Ambient IoT device data to a node (e.g., a base station or a UE 104). The NE 102 activates (e.g., triggers) a sub-population of Ambient IoT devices to enable transmission within a time window duration (e.g., a frame size). The NE 102 configures multiple transmission resources containing a random access channel (RACH) resource and one or more UL resources as a transmission occasion for the Ambient IoT devices.

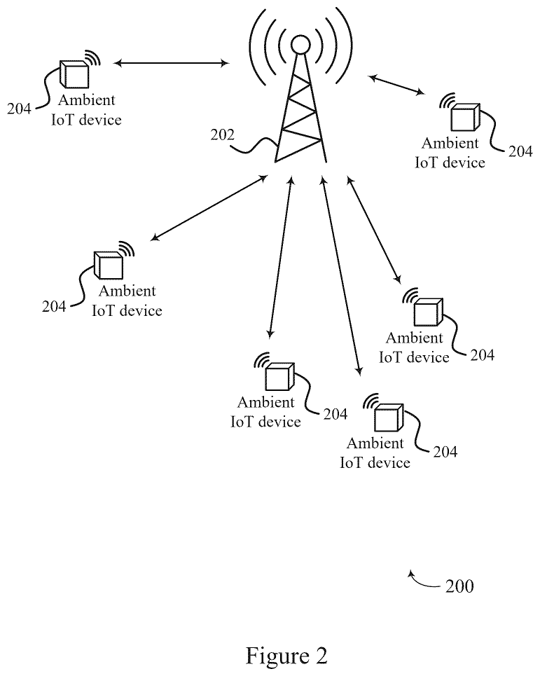

FIG. 2 illustrates an example of a wireless communications system 200 in accordance with aspects of the present disclosure. In some examples, the wireless communications system 200 implements aspects of the wireless communications system 100. For example, the wireless communications system 200 includes a NE 202 (e.g., a base station), and multiple low power (e.g., Ambient IoT devices) 204. Although a single NE 202 is illustrated, it is to be appreciated that the wireless communications system 100 can include any number of NEs, external nodes, intermediate nodes, carrier wave transmitters, and so forth. The NE 202 receives transmissions from the Ambient IoT devices 204 and may also be referred to as a reader or a reader device.

Each Ambient IoT device 204 may be classified or defined as a low power device if a power consumption level of the Ambient IoT device 204 satisfies (e.g., is less than) a threshold value. The Ambient IoT device 204 may include a low power processor to reduce the power consumption level of the Ambient IoT device 204. A low power processor may be a processor that operates with a power consumption level that satisfies (e.g., is less than) a threshold value. A low power processor and/or the Ambient IoT device 204 may have reduced functionality when compared with a processor or other wireless device that operates at a power consumption level that is greater than the threshold value. For example, the low power processor and/or the Ambient IoT device 204 may have reduced processing capabilities for decoding and generating signaling, may have reduced transmission and/or reception capabilities (e.g., transmission and/or reception range, among others), reduced energy storage capabilities (e.g., smaller battery), or the like when compared with a processor or wireless device that operates at a power consumption level that is greater than the threshold value.

In one or more implementations, the Ambient IoT device 204 may be a sensor (e.g., a tag), an actuator, an appliance, or another device capable of connecting to a wireless network. In some examples, the Ambient IoT device 204 is categorized according to a set of components and/or capabilities of the Ambient IoT devices, where the categories include one or more of an active Ambient IoT device category, a semi-passive Ambient IoT device category, and/or a passive Ambient IoT device category. An active Ambient IoT device includes a power source and an active radio frequency component, such as a transmitter and/or receiver component, for signal generation. The transmitter and/or receiver component may include one or more antennas for transmitting and receiving signaling. A semi-passive Ambient IoT device may have energy storage capabilities but may not include an active radio frequency component for signal generation. A passive Ambient IoT device may not have energy storage capabilities or an active radio frequency component.

In some cases, semi-passive Ambient IoT devices and passive Ambient IoT devices use backscattering techniques and/or energy harvesting for transmitting and/or receiving transmissions. In variations, an active Ambient IoT device may use a transmitter and/or receiver component for transmitting or receiving transmissions and/or may use backscattering techniques for transmitting and/or receiving transmissions. Semi-passive Ambient IoT devices may use the stored energy to amplify a signal when using backscattering techniques. Backscattering techniques include receiving signaling from a source (e.g., a node such as the NE 202 or a UE) and modulating a reflection of the incoming signaling towards a destination (e.g., a node such as the NE 202 or a UE). Thus, the Ambient IoT device 204 may not use an active receiver and/or transmitter component for receiving and transmitting signaling, which reduces a power consumption level of the device.

In some examples, the Ambient IoT device 204 may be capable of energy harvesting using energy harvesting techniques. For example, the Ambient IoT device 204 may extract energy from transmission waves from a source device (e.g., the NE 202) to power the Ambient IoT device 204. The source device may transmit the signaling using a continuous wave waveform in which the signaling has a constant amplitude and frequency and/or a carrier wave waveform in which the signaling has a periodic variation in amplitude, duration, and position. Signaling transmitted using a continuous wave waveform may be referred to as a continuous wave transmission, while signaling transmitted using a carrier wave waveform may be referred to as a carrier wave transmission. If the Ambient IoT device 204 includes an energy storage component, then the Ambient IoT device 204 may store the extracted energy for later use (e.g., to amplify a reflection of signal or to generate a new signal).

In recent years, IoT has attracted much attention in the wireless communication world. More things are expected to be interconnected for improving productivity, efficiency, and increasing comforts of life. Further reduction of size, complexity, and power consumption of IoT devices can enable the deployment of tens or even hundreds of billion IoT devices for various applications and provide added value across the entire value chain. It is impractical to power all the IoT devices by batteries that need to be replaced or recharged manually, which leads to high maintenance cost, serious environmental issues, and even safety hazards for some use cases (e.g., wireless sensor in electric power and petroleum industry).

Many existing wireless communication devices are powered by battery that needs to be replaced or recharged manually. The automation and digitalization of various industries open numbers of new markets considering new IoT technologies of supporting battery-less devices with no energy storage capability or devices with energy storage that do not need to be replaced or recharged manually. The form factor of such devices are expected to be reasonably small to convey the validity of target use cases.

Various use cases, traffic scenarios, device constraints of ambient power-enabled Internet of Things are considered and identification of new potential service requirements as well as new KPIs are considered. Devices being battery-less or with limited energy storage capability (e.g., using a capacitor) are considered and the energy is provided through the harvesting of radio waves, light, motion, heat, or any other power source.

Considering the limited size and complexity required by practical applications for battery-less devices with no energy storage capability or devices with limited energy storage that do not need to be replaced or recharged manually, the output power of energy harvester is typically from 1 microwatt (μW) to a few hundreds of μW. Existing cellular devices may not work well with energy harvesting due to their peak power consumption of higher than 10 milliwatts (mW).

An example type of application is asset identification, which presently resorts mainly to barcode and RFID in most industries. An advantage of these two technologies is the ultra-low complexity and small form factor of the tags. However, the limited reading range of a few meters usually requires handheld scanning which leads to labor intensive and time-consuming operations, or RFID portals or gates, which leads to costly deployments. Moreover, the lack of interference management scheme results in severe interference between RFID readers and capacity problems, especially in case of dense deployment. It is difficult to support large-scale network with seamless coverage for RFID.

Since existing technologies cannot meet all the requirements of target use cases, a new IoT technology is desired to open new markets within 3^{rd} Generation Partnership Project (3GPP) systems, whose number of connections and/or device density can be orders of magnitude higher than existing 3GPP IoT technologies. The new IoT technology is expected to provide complexity and power consumption orders of magnitude lower than the existing 3GPP low power wide area (LPWA) technologies (e.g., narrowband (NB)-IoT and enhanced machine type communication (eMTC)), and is expected to address use cases and scenarios that cannot otherwise be fulfilled based on existing 3GPP LPWA IoT technologies.

Assessment of Ambient IoT suitable for deployment in a 3GPP system that relies on ultra-low complexity devices with ultra-low power consumption for the very-low end IoT applications is taken into consideration. Addressing use cases and scenarios that cannot otherwise be fulfilled based on existing 3GPP LPWA IoT technology, e.g., NB-IoT including with reduced peak Tx power is taken into consideration.

A harmonized air interface design with reduced (e.g., minimized) differences (where appropriate) for Ambient IoT to enable the following devices is considered: a) an approximately 1 μW peak power consumption, has energy storage, initial sampling frequency offset (SFO) up to 10^{X} ppm, neither downlink (DL) nor UL amplification in the device, where X is to be decided; the device's UL transmission is backscattered on a carrier wave provided externally; b) less than or equal to a few hundred μW peak power consumption, has energy storage, initial SFO up to 10^{X} ppm, both DL and/or UL amplification in the device, where X is to be decided; the device's UL transmission may be generated internally by the device, or be backscattered on a carrier wave provided externally. The coverage design target is a largest distance of 10-50 meters with device indoors. Devices where a UE operates as an intermediate node under network (e.g., base station) control), with no RRC states, no mobility (e.g., at least no cell selection or re-selection-like function), no hybrid automatic repeat request (HARQ), no automatic repeat request (ARQ), is considered.

Deployment scenarios with the following characteristics are considered. A deployment and topology scenario with a base station and coexistence characteristics of micro-cell, co-site. A deployment and topology scenario with a UE as an intermediate node, under network (e.g., base station) control and base station and coexistence characteristics of macro-cell, co-site; and the location is of intermediate node is indoor. FR1 licensed spectrum in frequency division duplex (FDD). Spectrum deployment in-band to NR, in guard-band to LTE/NR, in one or more standalone bands. Traffic types DO-DTT, device-terminated (DT), with focus on rUC1 (indoor inventory) and rUC4 (indoor command). Whether the harmonized air interface design can address the device-originated autonomous (DO-A) use case is also considered.

The occurrence of transmission from Ambient IoT device (including backscattering when used) at least in UL spectrum is considered.

The following is considered: applicable largest (e.g., maximum) distance target values(s); latency suitable for use in RAN; 2-dimensional (2D) distribution of devices; deployment scenarios for coverage and coexistence evaluations; identify basic blocks or components of possible Ambient IoT device architectures, taking into account implementations of low-power low-complexity devices which meet the RAN design target for power consumption and complexity; link budget calculation for coverage, including whether or how to model carrier wave from one or more nodes inside or outside the connectivity topology.

The following is considered: appropriate and feasible solutions for Ambient IoT, including decisions on which functions, procedures, etc. are used, and providing at least desired (e.g., required) functionalities; positioning, restricted to functionalities which would have no, or little, specification impact; the feasibility and desired (e.g., required) functionalities for proximity determination.

For the Ambient IoT DL and UL, the following is considered: frame structure, synchronization and timing, random access; numerologies, bandwidths, and multiple access; waveforms and modulations; channel coding; downlink channel/signal aspects; uplink channel/signal aspects; scheduling and timing relationships; characteristics of carrier-wave waveform for a carrier wave provided externally to the Ambient IoT device, including for interference handling at Ambient IoT UL receiver, and at NR base station.

The following is also considered: functions used for an Ambient IoT compact protocol stack and lightweight signaling procedure to enable DO-DTT and DT data transmission; for example, paging, random access, data transmission, including radio resource control aspects, interactions with upper layers.

The following is also considered: impacts on signaling and procedures for CN-RAN interface, to enable paging, device context management, data transport; RAN architecture aspects, including whether support for split architecture is used; solutions for locating an Ambient IoT device with no specification impact, e.g., reusing existing user location report, or reduced (e.g., minimal) specification impact to convey location information to core network.

The following is also considered: coexistence of Ambient IoT and NR/LTE; RF for Ambient IoT, including Ambient IoT base station transmission and reception, Ambient IoT Device transmission and reception, intermediate node (e.g., UE), transmission and reception.

With respect to multiple access for Ambient IoT devices, there are two hierarchical steps to reduce the collisions due to connection density (e.g., 150 devices per 100 m2 for indoor scenarios). Firstly, identifying and selecting the Ambient IoT devices from multiple Ambient IoT devices to perform inventory. Selecting a subset of population of tags to the inventory round reduces the number of devices to inventoried thereby reducing the collision from devices that need not be inventoried. Secondly, handling of device collision within the inventory round when multiple devices are to be inventoried within a latency bound.

Anti-collision systems are procedures used to manage the reading from several Ambient IoT devices simultaneously. The design of the wireless communications system is expected to prevent the overlapping radio waves, emitted by different Ambient IoT devices, which end up creating destructive interference. The design of the wireless communications system is expected to manage the reading and writing of a larger number of Ambient IoT devices using the anti-collision algorithms, thereby regulating the time intervals and frequencies to read and write into the Ambient IoT device. With such techniques, the interference from collision can be managed and the risk of receiving incorrect or inaccurate information can be avoided.

Secondly, an efficient mechanism to schedule the devices within an inventory round is used due to the larger number of Ambient IoT devices. The efficiency is determined by the number of available occasions to the number of Ambient IoT devices for scheduling. If the available slots are more than the number of devices, then the efficiency is lower and if the available slots are less than the number of devices then more collisions happen. The Ambient IoT collision problem can be addressed by studying suitable multiple access methodology such as space (SDMA), time (TDMA), frequency (FDMA), code (CDMA) and a hybrid combination thereof. Such multiple access applied at the reader is transparent to the device tag due to the complexity. Multiple access methodologies are described below. The techniques discussed herein describe a hybrid approach of selecting a subpopulation of Ambient IoT devices for random access and to transmit data.

For a spatial division multiple access technique, the radio waves from a node are directed at different areas or sectorized to achieve spatially separated channel to read Ambient IoT devices and reuse frequencies. This technique depends on the indoor Sub 1 GHz antenna and sectorization configuration.

For a frequency division multiple access technique, the Ambient IoT devices are configured to transmit in different frequency channels. This technique manages frequency between nodes otherwise creating interference.

For a code division multiple access technique, devices transmit simultaneously in the same frequency channel by code-multiplexing using a pseudo random sequence. This technique introduces complexity to the device side but increases the efficiency.

For a frame slotted Aloha—TDMA technique, the Ambient IoT devices are activated to read or write one by one in slotted time domain manner. This technique is expected to handle collision when two devices try to transmit in the same slot otherwise the efficiency is lower.

For a dynamic frame slotted Aloha technique, the size of the frame available for device transmission is changed according to the number of devices. This technique iteratively adjusts frame size according to the collision. The reader does not move to the next frame until it finishes the current frame.

For a Q protocol technique, the device selects a random time slot within a time duration window provided by the reader for transmission. Q protocol is used in RFID and iteratively adjusts the frame size according to the collision. Since the slots are randomly chosen for transmission and when the frame size is larger than the number of devices it creates vacant slots affecting the efficiency.

For a query tree technique, devices respond with their IDs when the query command with binary prefix bit of 0 or 1 transmitted by the reader matches the device EPC ID. With this technique a high number of collisions occur particularly at the beginning of the identification procedure.

For a query window tree technique, the reader transmits the number of bits and devices respond with the query command. With this technique the command from reader uses a higher number of bits.

For a collision tree technique, improvement to the query tree protocol is made by identifying the collided bits and its location. This technique uses processing at the reader.

The following terminologies can be used for Ambient IoT when referring to processing time aspects. These times refer to a device (D), such as a wireless device (e.g., an Ambient IoT device) and another device (R) (e.g., a reader that reads signals transmitted or backscattered form the device D). T_{R2D} min refers to a minimum time between a reader to device (R2D) transmission and the corresponding device to reader (D2R) transmission following. T_{D2R} min refers to a minimum time between a D2R transmission and the corresponding R2D transmission following it. T_{R2D_R2D_min} refers to a minimum time between two different consecutive R2D transmissions to the same Ambient IoT device. T_{D2R_D2R_min} refers to a minimum time between two different consecutive D2R transmissions from the same Ambient IoT device.

Implementation restrictions for existing base stations or UEs is taken into consideration. Processing time being common or different for different Ambient IoT devices it taken into consideration. Processing time for different traffic types or command types (e.g., DT or DO-DTT) and/or different use case (e.g., Inventory or Command) are taken into consideration. Other timing aspects are taken into consideration.

An Ambient IoT device can include any of various receiver types. In one or more implementations, an Ambient IoT device receiver is a heterodyne envelope detector implemented at intermediate frequency (IF) level. Additionally or alternatively, the receiver is a homodyne/zero-IF envelope detector at the baseband (BB). Additionally or alternatively, the receiver is the orthogonal frequency division multiplexing (OFDM) based sequence or signal with time domain or frequency domain correlation.

In one or more implementations, the wireless device (e.g., Ambient IoT device) can periodically wake up to monitor for the Query command within the inventory round and once the inventory of the Ambient IoT device is finished, the Ambient IoT may sleep until the end of the inventory round. The Ambient IoT device might need to maintain a low (e.g., minimum) power consumption within the inventory round to maintain the RAM memory from erasing. Hence duty cycle-based operation is supported within the inventory round with different power state.

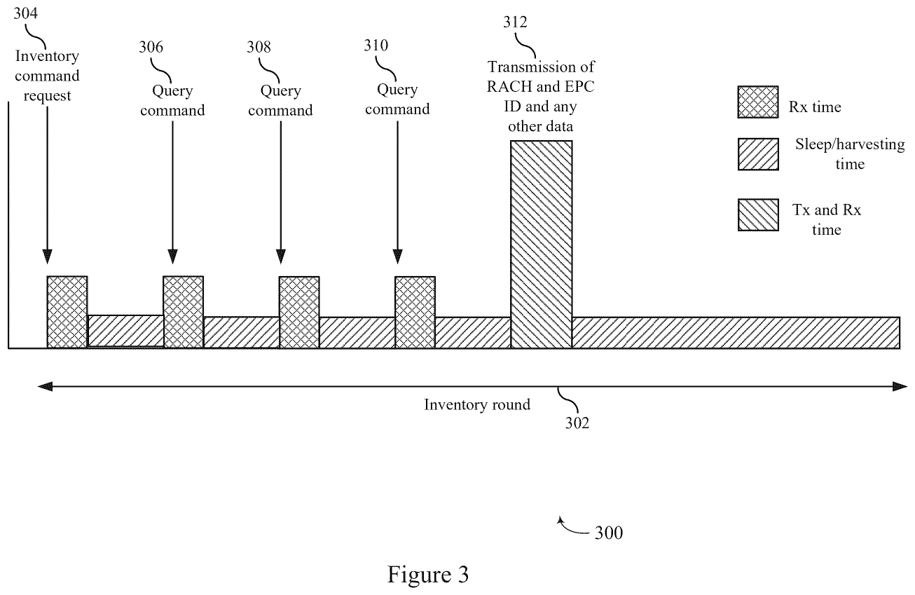

FIG. 3 illustrates an example 300 of duty cycle based operation in accordance with aspects of the present disclosure. The example 300 illustrates an example of duty cycle based operation of Ambient IoT device in an inventory round. Operation of the Ambient IoT device in the receive (Rx) state is illustrated with cross-hatching. Operation of the Ambient IoT device in the sleep or harvesting state is illustrated with diagonal lines from top left to lower right. Operation of the Ambient IoT device in the transmit (Tx) state (e.g., Tx and Rx state) is illustrated with diagonal lines from bottom left to top right.

The example 300 illustrates an inventory round 302. When an inventory command request 304 is received from the reader, the Ambient IoT device can start a duty cycle based operation where the Ambient IoT device periodically wakes up to receive a Query command 306, 308, or 310 from the reader. The query command may also be referred to a a Query message or a Query rep message. When the Ambient IoT device is to transmit, the Ambient IoT device transmits 312 and once it receives confirmation from the reader, the Ambient IoT device may continue to sleep until the end of the inventory round. The inventory command message or the query command or system information may provide the duty cycle periodicity, slot offset, and so forth for the Ambient IoT device to wake up and receive the periodic Query rep command from the reader.

As part of the inventory request command from the reader, the reader may configure one or more of the length of the inventory round, periodicity of the Query messages within the inventory round e.g., timing between the consecutive Query messages, periodicity of the Query rep message within the inventory round, parameter to assist energy aware scheduling for the Ambient IoT devices within the inventory round.

The resources are grouped such as to create a transmission or reception occasion for Ambient IoT D2R and R2D communication. Grouping of resources enables the transmission and reception of command from reader, transmission of random access, reception of acknowledgement, transmission of EPC ID and reception of confirmation from the reader without the need to do contention-based access for every transmission. The Ambient IoT device can transmit random access followed by EPC ID within a same occasion without contention-based slot selection (e.g., using a contention-less scheme, approach, or technique). While the contention-based selection procedure can be used to randomly select one of such occasions and/or to transmit random access, the resources for R2D and D2R communications within occasions are configured taking into consideration the processing timings for R2D, D2R transmissions. Furthermore, timing between two R2D consecutive occasions to receive the query command transmission within an inventory round is considered. Since the query message is periodic, the resource occasions are configured in between these consecutive query messages and the contention-based scheme chooses one of these occasions for transmitting the random access and receiving confirmation followed by the transmission of EPC ID. Additionally, or alternatively, the acknowledgment from the reader after successfully receiving the random access can contain dedicated resource or scheduling information to transmit the EPC ID using one or more resources.

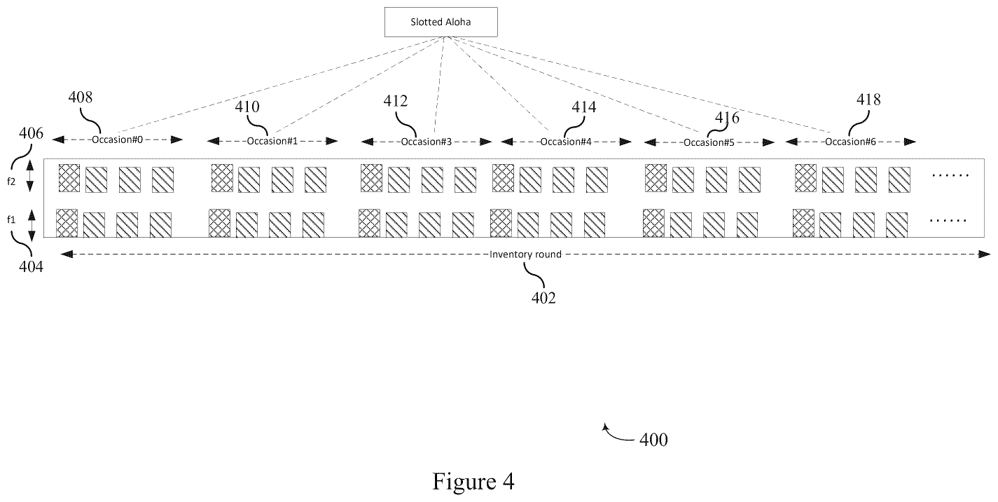

FIG. 4 illustrates an example 400 of grouping of resources in accordance with aspects of the present disclosure. The example 400 illustrates grouping of resources and selection of occasion using slotted aloha method. The example 400 illustrates an inventory round 402. In the example 400, TDM and frequency division multiplexing (FDM) of UL resources for Ambient IoT communication are illustrated (with different frequencies f1 404 and f2 406) and TDM of UL resources for Ambient IoT communication are illustrated. Multiple occasions 408, 410, 412, 414, 416, 418, . . . within an interval are also illustrated. Resources for transmission by the Ambient IoT of random access are illustrated with cross hatching and the for UL data are illustrated with diagonal lines.

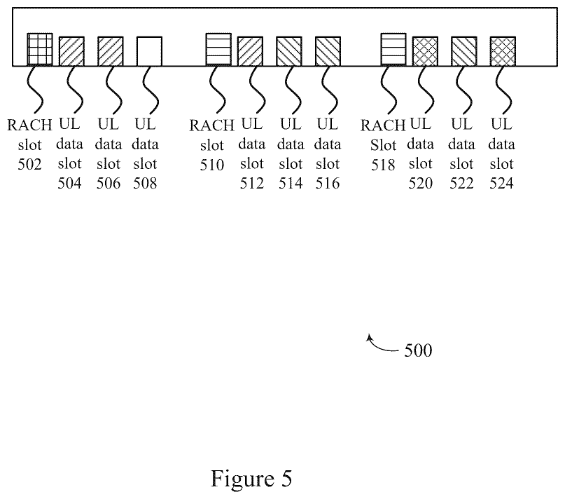

FIG. 5 illustrates an example 500 of uplink (UL) resource allocation in accordance with aspects of the present disclosure. The downlink (DL) and UL resource may not be uniformly distributed after the RACH, the DL and UL resource may be spread across other occasion so that Ambient IoT device may either perform multiple transmission due to segmentation, interleaved or repetition, and so forth. The first block in each occasion is a RACH resource and the remaining blocks are UL data resources. The example 500 illustrates one occasion with a RACH slot 502 and UL data slots 504, 506, and 508, another occasion with a RACH slot 510 and UL data slots 512, 514, and 516, and another occasion with a RACH slot 518 and data slots 520, 522, and 524.

In one or more implementations, currently, the slotted aloha scheme for RFID may randomly select a slot for transmission occasion within a window of an inventory process, however such slotted aloha mechanism does not take into consideration the energy availability at the device resulting in a device with less energy storage or energy availability being able to select a random slot beyond its available energy to receive or transmit, resulting in higher outage probability. The outage probability is defined as the number of devices successfully transmitting the EPC ID to the reader compared to the total availability of the devices participating in the inventory process. The reader may assist the energy aware scheduling for the Ambient IoT devices within the inventory process by dividing the duration of the inventory process into a multiple intervals where each interval contains X resource occasions to sustain X Query messages. The reader may also transmit the energy threshold associated with each of those intervals. The energy threshold is associated with the one or more intervals within the inventory round where the device can sustainability receive and transmit within the occasion in a selected interval.

Hence a formula can be used for selecting one of a plurality of intervals within the inventory round where each inventory round includes multiple occasions. The formula can be determined according to one or more of the following: the initial available energy at the Ambient IoT device during the start of the inventory round, harvesting from solar/light/vibrations or RF harvesting time according to the energy harvesting circuitry including capacitance and resistance, length of the inventory round, time duration between the query messages or time duration between occasion, number of intervals within the inventory round and duration in terms of occasion in each interval, energy consumption within an inventory session considering the energy consumed for each of the reception, transmission, sleep, synchronization, or wake up signal monitoring. In one or more implementations, the Ambient IoT device is pre-configured with the formula (e.g., at the time of manufacture of the Ambient IoT device). Additionally, or alternatively, the Ambient IoT may be configured with the formula by another device, such as the reader.

In one or more implementations, the energy aware scheduling takes into consideration the available energy of the Ambient IoT device. For example, the energy aware scheduling takes into consideration that the Ambient IoT device with less available energy (e.g., energy stored at the Ambient IoT device is less than a threshold amount) can be associated to or select an earlier (in time) interval, such as the first interval (or one of the first few intervals) within the inventory round so that the Ambient IoT device can transmit early within the first interval due to its limited energy. If the Ambient IoT device has approximately half available energy (e.g., energy stored at the Ambient IoT device is approximately half of the energy storage capacity of the Ambient IoT device) then the Ambient IoT device can be associated to or select the interval accordingly to transmit (e.g., an interval in approximately the middle of the inventory round). An Ambient IoT device having full available energy (e.g., the energy stored at the Ambient IoT device is within a threshold (e.g., 5%) of the energy storage capacity of the Ambient IoT device) and that can sustain operation until the end of the inventory round can be associated to or select one of the last set of intervals to select for transmission.

In one or more implementations, the reader transmits to the Ambient IoT devices the energy thresholds associated with each of the intervals in the inventory round. The Ambient IoT devices can use these thresholds to determine or select the interval in which the Ambient IoT device is to transmit. For example, a first interval (e.g., earliest in time) can be associated with 10%, a second interval (e.g., second earliest in time) can be associated with 20%, a third interval (e.g., third earliest in time) can be associated with 30%, and so forth. If the available energy at an Ambient IoT device is less than or equal to 10% of the energy storage capacity of the Ambient IoT device, then the Ambient IoT device selects or determines to transmit in the first interval. If the available energy at the Ambient IoT device is greater than 10% of the energy storage capacity of the Ambient IoT device but less than or equal to 20% of the energy storage capacity of the Ambient IoT device, then the Ambient IoT device selects or determines to transmit in the second interval. If the available energy at the Ambient IoT device is greater than 20% of the energy storage capacity of the Ambient IoT device but less than or equal to 30% of the energy storage capacity of the Ambient IoT device, then the Ambient IoT device selects or determines to transmit in the third interval, and so forth.

Additionally or alternatively, the energy aware scheduling takes into consideration the energy harvesting time and energy availability to transmit of the Ambient IoT devices. For example, an Ambient IoT device having less available energy to transmit may need to harvest more energy and thus can select one of the intervals according to the harvesting time (e.g., the amount of time it takes for the Ambient IoT device to harvest energy, such as a threshold amount of energy or an amount of energy to bring the Ambient IoT device up to a particular charge level (such as within a threshold amount, such as 5%, of the energy storage capacity of the Ambient IoT device)) and energy available for transmission within that interval (e.g., an interval at or near the end of the inventory round). If the Ambient IoT device has medium energy availability then the Ambient IoT device can select one of the intervals from the beginning of the inventory round or in the middle of the inventory round before the available energy of the Ambient IoT device drops below the energy for transmission threshold. An Ambient IoT device having full energy availability can select one of the last set of intervals assuming the Ambient IoT can sustain operation until then.

Hence the energy aware scheduling accounts for the energy availability at the device in selecting an occasion for transmission. The device with less energy availability may chose a slot early within their sustainable operation time to receive and transmit while device having larger availability of energy may chose a random occasion according to their sustainable operation time window. Further, the reader can be made aware of the sustainable operation timing of each side according to their instantaneous energy availability at the start of the inventory process or within the inventory round, or the reader may periodically transmit the command containing energy threshold values. The energy threshold can be the availability of energy at the device, hence devices with less or equal to the threshold value may chose a random slot within a window provided in the command.

For example, a device with 2 microfarad (μF) capacitance as energy storage may have an available energy of 1 microjoule (μJ) and with that considering the consumption of power state for receive (Rx) and periodic synchronization is around 55 microwatt (μW), sleep state power consumption to maintain RAM memory is 0.5 μW, transmit (Tx) power consumption is around 200 μW. Harvesting time with 20 kiloOhm (kOhm) resistance is around 200 millisecond (msec) to attain full charge of l μJ.

Considering that for each Query round the ambient IoT device may receive synchronization signal and query command then the total number of occasions that the Ambient IoT device may sustainably operate for receiving is 1 μJ/0.055 μJ which is around 18 occasion. If the transmission opportunity of the Ambient IoT is considered then the available energy for transmission=1 μJ/0.055 μJ >200 μW which is typically within the 14^{th} occasions. If each interval consists of 10 occasions then the Ambient IoT device may select the one of the occasions from the second interval for transmission.

Table 1 illustrates an example of radio frequency (RF) energy charging time (msec) considering different capacitance size and resistance.

TABLE 1

| R | | | | | | | | | | |
|---|---|---|---|---|---|---|---|---|---|---|
| (kΩ) | 1 μF | 2 μF | 3 μF | 4 μF | 5 μF | 6 μF | 7 μF | 8 μF | 9 μF | 10 μF |
| 1 | 5 | 10 | 15 | 20 | 25 | 30 | 35 | 40 | 45 | 50 |
| 20 | 100 | 200 | 300 | 400 | 500 | 600 | 700 | 800 | 900 | 1000 |
| 100 | 500 | 1000 | 1500 | 2000 | 2500 | 3000 | 3500 | 4000 | 4500 | 5000 |
| 1000 | 5000 | 10000 | 15000 | 20000 | 25000 | 30000 | 35000 | 40000 | 45000 | 50000 |

At the beginning of the inventory process, it may not be possible to assume that every Ambient IoT device is fully charged and able to withstand an entire inventory round with the stored energy. Hence, the Ambient IoT device may harvest energy to sustain the Tx/Rx operation within the inventory round. Also, the Ambient IoT device may harvest energy to sustain the Rx operation outside the inventory round to regularly monitor for the inventory request command from the reader. Table 1 shows the RF harvesting time within the inventory latency (the values 10000 or less) for 1 second (sec) and 10 sec respectively while the values 15000 or greater are outside the latency bound. Since the harvesting is an integral part of the Ambient IoT device, the minimum capacitance size and the resistance for harvesting is defined as part of the evaluation.

Additionally or alternatively, an Ambient IoT device reports the initial available energy to the reader (e.g., a current amount of energy stored at the Ambient IoT device, such as a number of μJ currently stored at the Ambient IoT device, or a percentage of the energy storage capacity of the Ambient IoT device (e.g., 25% or 60% of the energy storage capacity of the Ambient IoT device)) and based on the estimates of the energy consumption within a session considering reception, transmission, sleep and the duration of a session, the harvesting time, the reader may provide the scheduling grant selecting an occasion for the Ambient IoT device for transmission.

Additionally or alternatively, an Ambient IoT device having less energy storage or less initial available energy may not periodically wake up to receive every query message. Rather, the Ambient IoT device may have a longer sleep duration and may skip monitoring query messages. Such a skipping duration can be configured accordingly to the available energy of the Ambient IoT device to sustain the operation of the Ambient IoT device within the inventory round.

Additionally or alternatively, an ambient IoT device can select an occasion within an inventory round according to the contention-based scheme and select a transmission slot within the occasion for transmission of EPC ID according to the contention-less (also referred to as contention-free) approach as explained in the above.

In one or more implementations, the Ambient IoT device D2R transmission takes into consideration that the Ambient IoT device may run out of stored energy even during transmission. In case there is insufficient energy then the payload is segmented according to the available energy. The size of the payload segment in the frame is determined, for example, based on the available energy to transmit a frame containing the segment and control header information indicates the information about the next payload segment so that the reader can store the existing segments, otherwise the Ambient IoT device may retransmit all of the segments again resulting in unnecessary wastage of energy or the Ambient IoT device may harvest more energy to transmit the entire payload segment rather than transmitting the remaining payload segments.

A minimum time between the D2R and R2D communication and a minimum time between the D2R communication from the same Ambient IoT device can be flexible to take into consideration the time to harvest energy to transmit the remaining part of the payload segment to the reader. Hence, the energy aware transmission of payload segmentation from Ambient IoT device in D2R communication can take into account harvesting time in the scheduling/processing timings (T_{D2R_DER_min} and T_{D2R_min}) to transmit the remaining payload segments to the reader in case of payload segmentation.

The Ambient IoT device can periodically wake up to monitor for the Query command within the inventory round and once the inventory of the Ambient IoT device is finished, the Ambient IoT device may sleep (e.g., transition to a sleep mode) until the end of the inventory round. The Ambient IoT device may maintain a low (e.g., minimum) power consumption within the inventory round to maintain the RAM memory from erasing. Hence duty cycle-based operation is supported within the inventory round.

In one or more implementations, the Ambient IoT device may be inserted with a midamble e.g., an additional preamble within the Ambient IoT device payload frame structure for synchronization. The payload is segmented and the first segment is mapped using the binary modulated waveform such as on-off keying (OOK) or frequency-shift keying (FSK) waveform before the midamble, after the midamble is inserted the second segment of payload is mapped using the binary modulated waveforms. Cyclic redundancy check (CRC) bits can be added to each of the segments and then a final transport block CRC can optionally be added. The reader may request the transmission of a particular segment using segment index if the CRC fails for the segment. The segment is indexed, for example, from the ascending order from the starting position of the segment.

Accordingly, grouping of resource enabling the R2D and D2R communication within a resource occasion is discussed herein.

Configuring one of more intervals of set of occasions within each interval until the inventory duration is also discussed herein.

Determining the interval for selection and selection of occasion within the interval according to a formula is also discussed herein.

A formula to determine an interval includes at least one of available initial energy, harvesting time, duration of the inventory round, or time duration between consecutive query message.

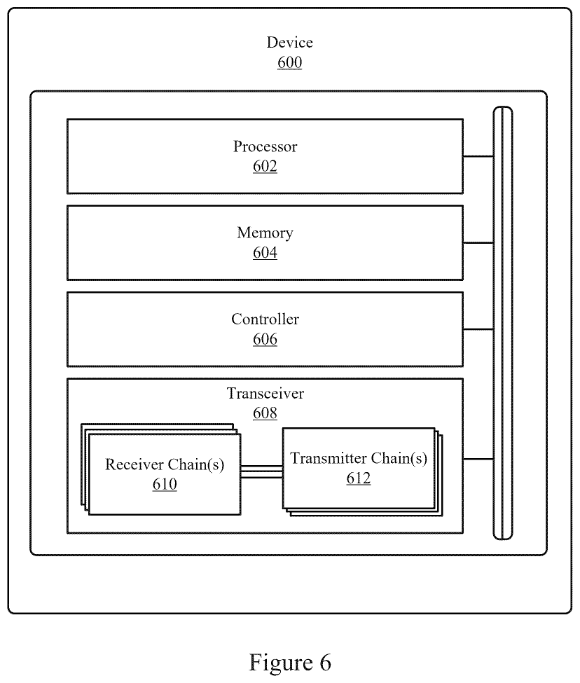

FIG. 6 illustrates an example of a device 600 in accordance with aspects of the present disclosure. The device 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces. The device 600 may be a low power device (e.g., an Ambient IoT device), a UE, an intermediate node, and so forth.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the device 600 to perform various functions of the present disclosure.

The memory 604 may include volatile or non-volatile memory. The memory 604 may store computer-readable, computer-executable code including instructions when executed by the processor 602 cause the device 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the device 600 to perform one or more of the functions described herein (e.g., executing, by the processor 602, instructions stored in the memory 604). For example, the processor 602 may support wireless communication at the device 600 in accordance with examples as disclosed herein. The device 600 may be configured to or operable to support a means for receiving a configuration for communication with a reader; selecting, based at least in part on a rule or formula, an interval of a plurality of intervals for transmission; and transmitting, within an occasion of one of the plurality of intervals for transmission, at least one of random access or an electronic product code identifier.

Additionally, the device 600 may be configured to support any one or combination of where the configuration indicates at least one of a duration of an inventory round or multiple intervals within the inventory round, where each of the multiple intervals includes multiple occasions; where the rule or formula is based at least in part on one or more of a duration of an inventory round, a duration between query messages in the inventory round, an energy harvesting time for the wireless device according to a harvesting source, an energy harvesting time for the wireless device based at least in part on a capacitance size and resistance of the wireless device, an available energy of the wireless device, or an estimated energy consumption for at least one of reception, sleep, transmission, or synchronization by the wireless device; selecting the occasion; selecting an occasion within an inventory round according to a contention based scheme; selecting a transmission slot within the occasion for transmission of the electronic product code identifier according to a contention less approach; where the selecting comprises selecting the interval based at least in part on available energy at the wireless device; where the selecting comprises selecting an interval of the plurality of intervals earlier in time based at least in part on available energy at the wireless device being less than a threshold amount; where the selecting comprises selecting the interval based at least in part on an energy harvesting time of the wireless device; transmitting an indication of available energy at the wireless device; entering, after transmission of at least one of the random access or the electronic product code identifier, a sleep mode until an inventory round that includes the plurality of intervals for transmission has ended; where the wireless device comprises a low power device; where the wireless device comprises an Ambient IoT device.

Additionally, or alternatively, the device 600 may support at least one memory (e.g., the memory 604) and at least one processor (e.g., the processor 602) coupled with the at least one memory and configured to or operable to cause the UE to: receive a configuration for communication with a reader; select, based at least in part on a rule or formula, an interval of a plurality of intervals for transmission; transmit, within an occasion of one of the plurality of intervals for transmission, at least one of random access or an electronic product code identifier.

Additionally, the device 600 may be configured to or operable to support any one or combination of where the configuration indicates at least one of a duration of an inventory round or multiple intervals within the inventory round, where each of the multiple intervals includes multiple occasions; where the rule or formula is based at least in part on one or more of a duration of an inventory round, a duration between query messages in the inventory round, an energy harvesting time for the wireless device according to a harvesting source, an energy harvesting time for the wireless device based at least in part on a capacitance size and resistance of the wireless device, an available energy of the wireless device, or an estimated energy consumption for at least one of reception, sleep, transmission, or synchronization by the wireless device; where the at least one processor is further configured to or operable to cause the wireless device to select the occasion; where the at least one processor is further configured to or operable to cause the wireless device to select the occasion according to a contention-based scheme; where the at least one processor is further configured to or operable to cause the wireless device to select a transmission slot within the occasion for transmission of the electronic product code identifier according to a contention-less approach; where to select the interval, the at least on processor is further configured to or operable to cause the wireless device to select the interval based at least in part on available energy at the wireless device; where to select the interval, the at least on processor is further configured to or operable to cause the wireless device to select an interval of the plurality of intervals earlier in time based at least in part on available energy at the wireless device being less than a threshold amount; where the at least one processor is further configured to or operable to cause the wireless device to select the interval based at least in part on an energy harvesting time of the wireless device; where the at least one processor is further configured to or operable to cause the wireless device to transmit an indication of available energy at the wireless device; where the at least one processor is further configured to or operable to cause the wireless device to, after transmission of at least one of the random access or the electronic product code identifier, enter a sleep mode until an inventory round that includes the plurality of intervals for transmission has ended; where the wireless device comprises a low power device; the wireless device comprises an Ambient IoT device.

The controller 606 may manage input and output signals for the device 600. The controller 606 may also manage peripherals not integrated into the device 600. In some implementations, the controller 606 may utilize an operating system such as iOS®, ANDROID®, WINDOWS®, or other operating systems. In some implementations, the controller 606 may be implemented as part of the processor 602.

In some implementations, the device 600 may include at least one transceiver 608. In some other implementations, the device 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

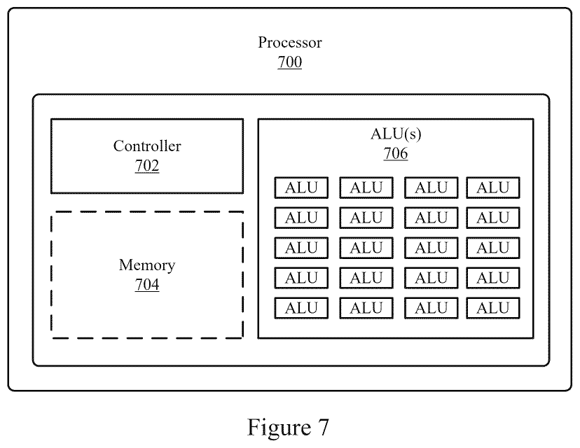

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory addresses of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, ALUs 706, and other functional units of the processor 700.

The memory 704 may include one or more caches (e.g., memory local to or included in the processor 700 or other memory, such as RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, and the controller 702, and may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 may be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support at least one controller (e.g., the controller 702) coupled with at least one memory (e.g., the memory 704) and configured to or operable cause the processor to: receive a configuration for communication with a reader; select, based at least in part on a rule or a formula, an interval of a plurality of intervals for transmission; transmit, within an occasion of one of the plurality of intervals for transmission, at least one of random access or an electronic product code identifier.

Additionally, the processor 700 may be configured to or operable to support any one or combination of where the configuration indicates at least one of a duration of an inventory round or multiple intervals within the inventory round, where each of the multiple intervals includes multiple occasions; where the rule or formula is based at least in part on one or more of a duration of an inventory round, a duration between query messages in the inventory round, an energy harvesting time for the processor according to a harvesting source, an energy harvesting time for the processor based at least in part on a capacitance size and resistance of the processor, an available energy of the processor, or an estimated energy consumption for at least one of reception, sleep, transmission, or synchronization by the processor; where the at least one controller is further configured to or operable to cause the processor to select the occasion; where the at least one controller is further configured to or operable to cause the processor to select an occasion within an inventory round according to a contention-based scheme; where the at least one controller is further configured to or operable to cause the processor to select a transmission slot within the occasion for transmission of the electronic product code identifier according to a contention-less approach; where to select the interval, the at least one controller is further configured to or operable to cause the processor to select the interval based at least in part on available energy at the processor; where to select the interval, the at least one controller is further configured to or operable to cause the processor to select an interval of the plurality of intervals earlier in time based at least in part on available energy at the processor being less than a threshold amount; where the at least one controller is further configured to or operable to cause the processor to select the interval based at least in part on an energy harvesting time of the processor; where the at least one controller is further configured to or operable to cause the processor to transmit an indication of available energy at the processor; where the at least one controller is further configured to or operable to cause the processor to, after transmission of at least one of the random access or the electronic product code identifier, enter a sleep mode until an inventory round that includes the plurality of intervals for transmission has ended; where the processor is included in a low power device; where the processor is included in an Ambient IoT device.

The processor 700 may support wireless communication in accordance with examples as disclosed herein. The processor 700 may be configured to or operable to support at least one controller (e.g., the controller 702) coupled with at least one memory (e.g., the memory 704) and configured to or operable to cause the processor to: at least one controller coupled with at least one memory and configured to or operable to cause the processor to: transmit a configuration for communication with a wireless device for selection of an interval of a plurality of intervals for transmission; receive, within an occasion of one of the plurality of intervals for transmission, at least one of random access or an electronic product code identifier.

Additionally, the processor 700 may be configured to or operable to support any one or combination of where the configuration indicates at least one of a duration of an inventory round or multiple intervals within the inventory round, where each of the multiple intervals includes multiple occasions; where the at least one processor is further configured to or operable to cause the processor to receive an indication of available energy at the wireless device; where the wireless device comprises a low power device; the wireless device comprises an Ambient IoT device.

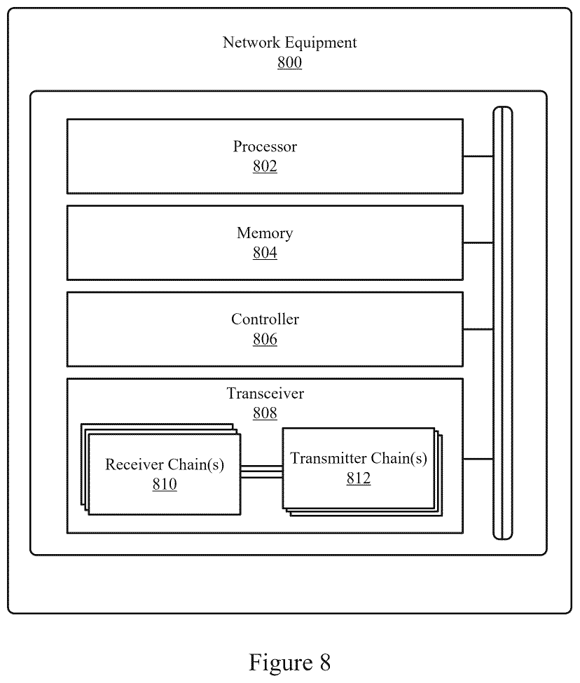

FIG. 8 illustrates an example of a NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces. The NE 800 may be any of a variety of different NEs as discussed above, such as an intermediate node, a TRP, a base station, any device that receives an UL transmission or backscatter transmission, an external node.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to support a means for transmitting a configuration for communication with a wireless device for selection of an interval of a plurality of intervals for transmission; and receiving, within an occasion of one of the plurality of intervals for transmission, at least one of random access or an electronic product code identifier.

Additionally, the NE 800 may be configured to support any one or combination of where the configuration indicates at least one of a duration of an inventory round or multiple intervals within the inventory round, where each of the multiple intervals includes multiple occasions; receiving an indication of available energy at the wireless device; where the wireless device comprises a low power device; where the wireless device comprises an Ambient IoT device.

Additionally, or alternatively, the NE 800 may support at least one memory (e.g., the memory 804) and at least one processor (e.g., the processor 802) coupled with the at least one memory and configured to cause the NE 800 to: transmit a configuration for communication with a wireless device for selection of an interval of a plurality of intervals for transmission; receive, within an occasion of one of the plurality of intervals for transmission, at least one of random access or an electronic product code identifier.

Additionally, the NE 800 may be configured to support any one or combination of where the configuration indicates at least one of a duration of an inventory round or multiple intervals within the inventory round, where each of the multiple intervals includes multiple occasions; where the at least one processor is further configured to or operable to cause the base station to receive an indication of available energy at the wireless device; where the wireless device comprises a low power device; where the wireless device comprises an Ambient IoT device.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

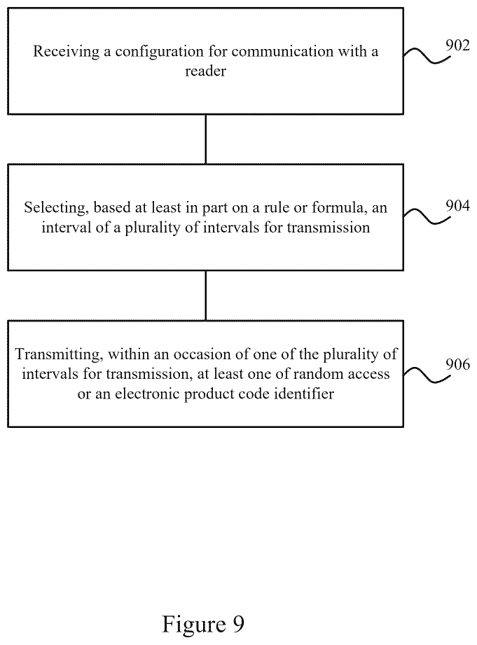

FIG. 9 illustrates a flowchart of a method in accordance with aspects of the present disclosure. The operations of the method may be implemented by a device as described herein. In some implementations, the device may execute a set of instructions to control the function elements of the device to perform the described functions.

At 902, the method may include receiving a configuration for communication with a reader. The operations of 902 may be performed in accordance with examples as described herein. In some implementations, aspects of the operations of 902 may be performed by a device as described with reference to FIG. 6, such as an Ambient IoT device.

At 904, the method may include selecting, based at least in part on a rule or formula, an interval of a plurality of intervals for transmission. The operations of 904 may be performed in accordance with examples as described herein. In some implementations, aspects of the operations of 904 may be performed by a device as described with reference to FIG. 6, such as an Ambient IoT device.

At 906, the method may include transmitting, within an occasion of one of the plurality of intervals for transmission, at least one of random access or an electronic product code identifier. The operations of 906 may be performed in accordance with examples as described herein. In some implementations, aspects of the operations of 906 may be performed by a device as described with reference to FIG. 6, such as an Ambient IoT device.

It should be noted that the method described herein describes a possible implementation, and that the operations and the steps may be rearranged or otherwise modified and that other implementations are possible.

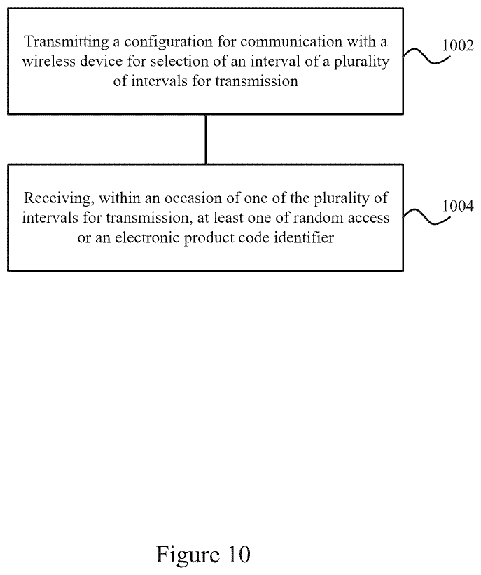

FIG. 10 illustrates a flowchart of a method in accordance with aspects of the present disclosure. The operations of the method may be implemented by a NE as described herein. In some implementations, the NE may execute a set of instructions to control the function elements of the NE to perform the described functions.

At 1002, the method may include transmitting a configuration for communication with a wireless device for selection of an interval of a plurality of intervals for transmission. The operations of 1002 may be performed in accordance with examples as described herein. In some implementations, aspects of the operations of 1002 may be performed by a NE as described with reference to FIG. 8.

At 1004, the method may include receiving, within an occasion of one of the plurality of intervals for transmission, at least one of random access or an electronic product code identifier. The operations of 1004 may be performed in accordance with examples as described herein. In some implementations, aspects of the operations of 1004 may be performed by a NE as described with reference to FIG. 8.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A wireless device for wireless communication, comprising:
at least one memory; and
at least one processor coupled with the at least one memory and operable to cause the wireless device to:
receive a configuration for communication with a reader;
select, based at least in part on a rule or formula, an interval of a plurality of intervals for transmission;
transmit, within an occasion of one of the plurality of intervals for transmission, at least one of random access or an electronic product code identifier.

2. The wireless device of claim 1, wherein the configuration indicates at least one of a duration of an inventory round or multiple intervals within the inventory round, wherein each of the multiple intervals includes multiple occasions.

3. The wireless device of claim 1, wherein the rule or formula is based at least in part on one or more of a duration of an inventory round, a duration between query messages in the inventory round, an energy harvesting time for the wireless device according to a harvesting source, an energy harvesting time for the wireless device based at least in part on a capacitance size and resistance of the wireless device, an available energy of the wireless device, or an estimated energy consumption for at least one of reception, sleep, transmission, or synchronization by the wireless device.

4. The wireless device of claim 1, wherein the at least one processor is further operable to cause the wireless device to select the occasion.

5. The wireless device of claim 4, wherein the at least one processor is further operable to cause the wireless device to select the occasion according to a contention-based scheme.

6. The wireless device of claim 5, wherein the at least one processor is further operable to cause the wireless device to select a transmission slot within the occasion for transmission of the electronic product code identifier according to a contention-less approach.

7. The wireless device of claim 1, wherein to select the interval, the at least on processor is further operable to cause the wireless device to select the interval based at least in part on available energy at the wireless device.

8. The wireless device of claim 1, wherein to select the interval, the at least on processor is further operable to cause the wireless device to select an interval of the plurality of intervals earlier in time based at least in part on available energy at the wireless device being less than a threshold amount.

9. The wireless device of claim 1, wherein the at least one processor is further operable to cause the wireless device to select the interval based at least in part on an energy harvesting time of the wireless device.

10. The wireless device of claim 1, wherein the at least one processor is further operable to cause the wireless device to transmit an indication of available energy at the wireless device.

11. The wireless device of claim 1, wherein the at least one processor is further operable to cause the wireless device to, after transmission of at least one of the random access or the electronic product code identifier, enter a sleep mode until an inventory round that includes the plurality of intervals for transmission has ended.

12. The wireless device of claim 1, wherein the wireless device comprises a low power device.

13. The wireless device of claim 1, wherein the wireless device comprises an Ambient Internet of Things (IoT) device.

14. A method performed by a wireless device, the method comprising:
receiving a configuration for communication with a reader;
selecting, based at least in part on a rule or formula, an interval of a plurality of intervals for transmission; and
transmitting, within an occasion of one of the plurality of intervals for transmission, at least one of random access or an electronic product code identifier.

15. The method device of claim 14, wherein the configuration indicates at least one of a duration of an inventory round or multiple intervals within the inventory round, wherein each of the multiple intervals includes multiple occasions.

16. The method device of claim 14, wherein the rule or formula is based at least in part on one or more of a duration of an inventory round, a duration between query messages in the inventory round, an energy harvesting time for the wireless device according to a harvesting source, an energy harvesting time for the wireless device based at least in part on a capacitance size and resistance of the wireless device, an available energy of the wireless device, or an estimated energy consumption for at least one of reception, sleep, transmission, or synchronization by the wireless device.

17. The method device of claim 14, further comprising wherein the selecting comprises selecting the interval based at least in part on available energy at the wireless device.

18. A base station for wireless communication, comprising:
at least one memory; and
at least one processor coupled with the at least one memory and operable to cause the base station to:
transmit a configuration for communication with a wireless device for selection of an interval of a plurality of intervals for transmission;
receive, within an occasion of one of the plurality of intervals for transmission, at least one of random access or an electronic product code identifier.

19. The base station of claim 18, wherein the configuration indicates at least one of a duration of an inventory round or multiple intervals within the inventory round, wherein each of the multiple intervals includes multiple occasions.

20. A method performed by a base station, the method comprising:
transmitting a configuration for communication with a wireless device for selection of an interval of a plurality of intervals for transmission; and
receiving. within an occasion of one of the plurality of intervals for transmission, at least one of random access or an electronic product code identifier.
